(19) United States
(12) Patent Application Publication
(10) Pub. No.: US 2008/0173358 A1
(43) Pub. Date: Jul. 24, 2008

(54) SYSTEM FOR ADDING A FUEL ADDITIVE TO A FUEL TANK

(76) Inventor: James Guldi, Lapeer, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/014,175

(22) Filed: Jan. 15, 2008

Related U.S. Application Data
(60) Provisional application No. 60/885,515, filed on Jan. 18, 2007.

(51) Int. Cl. B67D 5/08; G05D 7/00

(52) U.S. Cl. 137/351; 137/565.16; 700/282

(57) ABSTRACT

A system for adding a fuel additive to a fuel tank. The system includes a container which contains the fuel additive and a pump assembly having its inlet open to the container and an outlet fluidly connected to the fuel tank. A pump controller includes a fuel amount input mechanism for inputting the amount of fuel supplied to the fuel tank. The controller selectively activates the pump assembly in an amount necessary to obtain a predetermined ratio of fuel to additive in the fuel tank.

### CROSS REFERENCE TO RELATED APPLICATIONS

This application claims priority of U.S. Provisional Patent Application Ser. No. 60/885,515 filed Jan. 18, 2007, which is incorporated herein by reference.

### BACKGROUND OF THE INVENTION

I. Field of the Invention

The present invention relates generally to a system for adding a fuel additive to a fuel tank.

II. Description of Related Art

Most semi trucks of the type used to haul goods utilize diesel fuel in part because of the relatively low cost of diesel fuel as compared to gasoline. However, even diesel fuel has become relatively expensive in recent times thus increasing the overall cost of operating the truck.

In order to reduce the fuel cost, many operators of semi trucks add a fuel additive to the vehicle fuel. Such fuel additives not only increase the efficiency of the fuel, and thus the miles per gallon obtained by the operator of the vehicle, but also serve to clean the engine. Furthermore, in colder climates, many additives contain an anti-gelling formula to prevent the diesel fuel from becoming overly viscous in cold weather.

In order to obtain the maximum benefit from the fuel additive, however, it is necessary to add the fuel additive to the fuel tank of the truck so that an accurate ratio of the fuel to fuel additive is obtained. This, however, is inconvenient and difficult to achieve. In particular, when the fuel tank of the truck is filled, usually an odd number of gallons of diesel fuel are added to the tank. Consequently, it is necessary for the operator of the truck to not only calculate the proper amount of additive to be added to the fuel tank, but also to accurately measure that amount of fuel additive which is added to the fuel tank. Consequently, many operators of trucks either add the wrong amount of fuel additive to the fuel tank or simply do not add any additive at all. In both cases, less than ideal operation of the truck is achieved.

### SUMMARY OF THE PRESENT INVENTION

The present invention provides a system for adding a fuel additive to a fuel tank which overcomes the above-mentioned disadvantages of the previously known devices.

In brief, the system of the present invention includes a container mounted to the truck and which is adapted to contain the fuel additive. Any conventional means, such as a saddle assembly, may be utilized to mount the container to the truck.

A pump assembly includes an inlet which is fluidly connected to the additive container. An outlet from the pump assembly is then fluidly connected to the fuel tank. Consequently, upon activation of the pump assembly, the pump assembly pumps the fuel additive from the container and into the fuel tank for the truck.

A pump controller is provided for controlling the activation, and duration, of the pump assembly. The pump controller includes a fuel amount input mechanism, such as a keypad, for inputting the amount of fuel supplied to the truck. A processor in the controller, such as a microprocessor, then calculates the proper amount of fuel additive in response to the keypad input. The processor then selectively activates the pump assembly in an amount and for a time necessary to obtain the desired predetermined ratio of fuel additive to fuel in the fuel tank.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a truck with the system of the present invention;

FIG. 2 is an elevational and semi-diagrammatic view of the preferred embodiment of the system of the present invention;

FIG. 3 is a schematic of the system of the present invention; and

FIG. 4 is an elevational view illustrating an exemplary means for mounting the fuel additive container to the truck.

### DETAILED DESCRIPTION OF A PREFERRED EMBODIMENT OF THE PRESENT INVENTION

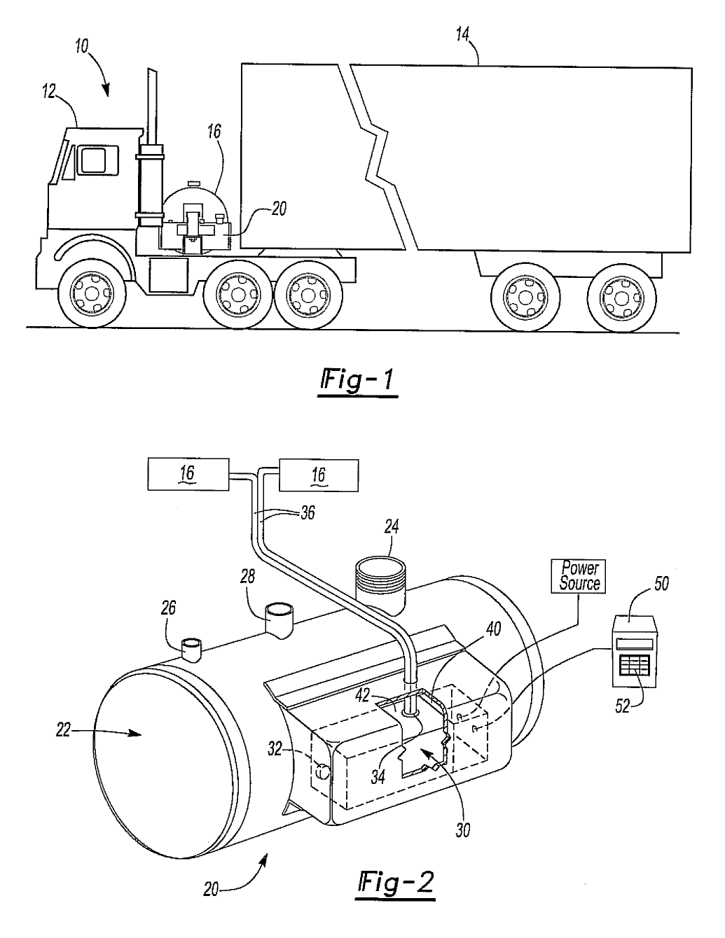

With reference first to FIG. 1, a semi truck 10 of the type used to haul goods is shown. Typically, the truck 10 includes a cab 12 and a cargo carrier 14. The cargo carrier 14 may be either joined to the cab 12 or connected to the cab 12 by a fifth wheel arrangement.

Typically, the truck 10 is powered by diesel fuel which is contained within one or more fuel tanks 16. Diesel fuel is preferred due to its relatively low cost as compared to gasoline.

A system 20, which will subsequently be described in greater detail, is mounted to the truck 10. As will be subsequently described in greater detail, the system 20 selectively adds a fuel additive to the diesel fuel contained within the fuel tank 16.

With reference now to FIG. 2, the system 20 is shown in greater detail and includes a container 22 which contains a fuel additive. The container 22 includes a filler neck 24 for adding the fuel additive to the container 22. Similarly, a rollover vent valve 26 is also provided on the container 22 on its top. A pickup tube 28 is also preferably provided on the container 22.

Still referring to FIG. 2, the system 20 includes a pump assembly 30 which may be mounted on the container 22. The pump assembly 30 includes an inlet 32 open to the interior of the container 22 and thus to the fuel additive contained within the container 22. The pump assembly 30 also includes an outlet 34 which is fluidly connected by one or more fluid lines 36 to the fuel tank or fuel tanks 16.

With reference now to FIGS. 2 and 3, the pump assembly 30 includes an electric motor 40 to control the activation of a pump 42 which pumps fuel additive from the container 22 into the fuel tanks 16. Consequently, the speed and duration of the motor 40 is proportional to the amount of fuel additive pumped from the container 22 into the fuel tanks 16. Preferably, the motor 40 is a stepper motor so that the number of rotations of the motor 40, and thus the amount of fuel additive pumped from the container 22, may be accurately controlled.

Still referring to FIGS. 2 and 3, a motor controller 50 is provided to control the activation of the motor 40 and thus the amount of fuel additive pumped from the container 22 to the fuel tank 16. The motor controller 50 includes a fuel amount input mechanism 52, such as a keypad, which allows the operator of the truck to input the amount of fuel added to the fuel tank 16. The output from the fuel amount input mechanism 52 is coupled as an input signal to a processor 54, such as a microprocessor.

With reference now particularly to FIG. 3, the processor 54 is programmed by a program contained in memory 56 to calculate the amount of fuel additive to be added to the fuel tank 16 as a function of the input on the input mechanism 52. The processor 54 also calculates the amount and duration of activation of the motor 40 which is necessary to pump the calculated amount of fuel additive from the container 22 and to the fuel tank 16.

Following calculation of the proper amount of fuel additive, the processor 54 generates an output signal to a stepper motor controller 56. The stepper motor controller 56, in turn, controls the activation of the stepper motor 40 which is mechanically coupled to the pump 42.

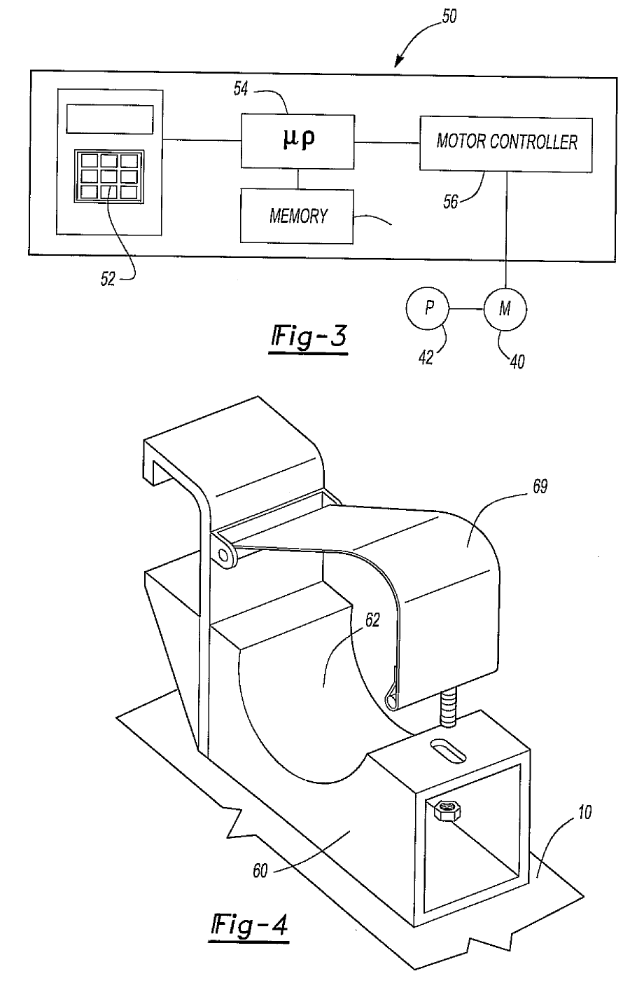

With reference now to FIG. 4, any conventional means may be utilized to mount the container 22 to the truck 10. One such means is shown in FIG. 4 and includes a saddle 60 having a saddle surface 62 which is attached to the truck 10. With the container 22 positioned on the surface 62, the saddle surface 62 and container flatly abut against each other. An elongated strap 64 then extends over the top of the container 22 to secure the container 22 to the saddle 60.

In practice, the operator of the truck 10 adds diesel fuel to the fuel tank 16 in the conventional fashion. After the operator has finished adding fuel to the fuel tank, the operator notes the amount of gallons of diesel fuel added to the fuel tank. The operator then inputs this amount of diesel fuel to the pump controller 50 by the input mechanism 52. The processor 54 then automatically activates the pump 42 through the servo motor controller 56 and servo motor 40 to achieve the correct amount of fuel additive to the fuel tank to maintain a predetermined fuel additive to fuel ratio.

Having described my invention, many modifications thereto will become apparent without deviation from the spirit of the present invention as defined by the scope of the appended claims.

I claim:

1. A system for adding a fuel additive to a fuel tank comprising:
a container adapted to contain a fuel additive,
a pump assembly having an inlet open to the additive container and an outlet fluidly connected to the fuel tank,
a pump controller having a fuel amount input mechanism for inputting the amount of fuel supplied to the fuel tank, said controller selectively activating said pump assembly in an amount necessary to obtain a predetermined ratio of fuel to additive in the fuel tank.

2. The invention as defined in claim 1 wherein said input mechanism comprises a keypad.

3. The invention as defined in claim 1 wherein said pump assembly comprises a pump having a rotary drive input and an electric motor having a rotary drive output mechanically coupled to said pump rotary drive input.

4. The invention as defined in claim 3 wherein said pump comprises a stepper motor and a stepper motor controller.

5. The invention as defined in claim 4 wherein said pump controller comprises a microprocessor having outputs coupled as input signals to said stepper motor controller.

6. The invention as defined in claim 5 wherein said microprocessor is programmed to calculate the proper amount of fuel additive in response to an input on said input mechanism and to generate output signals to said stepper motor controller to activate said stepper motor for a time sufficient to pump said proper amount of fuel additive from said container to the fuel tank.

7. The invention as defined in claim 1 and comprising a saddle having a surface complementary to the surface of the container and a strap which extends over the container when positioned on said saddle.
